(19) United States
(12) Patent Application Publication
(10) Pub. No.: US 2022/0277243 A1
(43) Pub. Date: Sep. 1, 2022

(54) STEEL FRAME BUILDING CONSTRUCTION CYCLE MANAGEMENT SOFTWARE

(71) Applicant: ConXtech, Inc., Pleasanton, CA (US)

(72) Inventors: John S. Boyd, Oakland, CA (US); Brian Hood, San Francisco, CA (US); Raymond David, Dublin, CA (US); Brent Casio Dugan, Brentwood, CA (US)

(73) Assignee: ConXtech, Inc., Pleasanton, CA (US)

(21) Appl. No.: 17/683,273

(22) Filed: Feb. 28, 2022

Related U.S. Application Data
(60) Provisional application No. 63/154,613, filed on Feb. 26, 2021.

(51) Int. Cl. G06Q 10/06; G06Q 50/08; G06F 16/26

(52) U.S. Cl. CPC G06Q 10/06313; G06Q 50/08; G06F 16/26

(57) ABSTRACT

A computer implemented method of managing construction of a steel building frame is disclosed, including defining a part database including beams, columns, and components of a full moment collar assembly, storing historical pricing data for the parts in the part database, and creating a station layout for a steel fabrication facility and receiving digital. The method further includes receiving digital models of a plurality of buildings, each including a steel frame having beams and columns connected by full moment collar assemblies, and parsing the received digital models to generate a list of parts in the plurality of buildings a defined in the part database. The method further includes generating routes and stages for the beams, the columns, and the components of the full moment collar assemblies through the stations of the steel fabrication facility, and modifying the digital model of at least one of the plurality of buildings to improve efficiency of the generated routes and stages.

### CROSS-REFERENCES

This application claims the benefit under 35 U.S.C. § 119(e) of the priority of U.S. Provisional Patent Application Ser. No. 63/154,613, filed Feb. 26, 2021, the entirety of which is hereby incorporated by reference for all purposes. The following related applications and materials are also incorporated by reference herein, in their entireties, for all purposes: U.S. Pat. No. 11,236,501; U.S. Patent Publication No. 2019/0247963; U.S. Patent Publication No. 2019/0247962; and U.S. Pat. No. 11,040,419.

### BACKGROUND

Software is becoming increasingly useful in all stages of building construction, from design through erection. Available software frequently focuses on managing one stage, such as digital design modelling, project budgeting, steel fabrication, or erection logistics; and/or on management of individual projects. Individual project or stage planning can miss out on efficiency improvements and cost savings available at an organizational level.

Such software is also generalized to be applicable for the greatest number of users, and therefore is built around standard construction materials and methods. Use of the software for custom materials, components, or technologies can be difficult, time-consuming, and prone to errors. Full cycle software is needed that is designed to allow simple integration of custom elements and holistic management of a portfolio of construction projects.

### SUMMARY

The present disclosure provides systems, apparatus, and methods relating to construction cycle management. In some examples, a computer implemented method of managing construction of a steel building frame may include defining a part database including beams, columns, and components of a full moment collar assembly, storing historical pricing data for the parts in the part database, and creating a station layout for a steel fabrication facility and receiving digital. The method may further include receiving digital models of a plurality of buildings, each including a steel frame having beams and columns connected by full moment collar assemblies, and parsing the received digital models to generate a list of parts in the plurality of buildings a defined in the part database. The method may further include generating routes and stages for the beams, the columns, and the components of the full moment collar assemblies through the stations of the steel fabrication facility, and modifying the digital model of at least one of the plurality of buildings to improve efficiency of the generated routes and stages.

In some examples, a computer program product for managing construction of a steel building frame may include a non-transitory computer-readable storage medium having computer-readable program code embodied in the storage medium, the computer-readable program code configured to cause a data processing system to display a graphical user interface. The computer-readable program code may include at least one instruction to define a part database including beams, columns, and components of a full moment collar assembly, at least one instruction to store historical pricing data for the parts in the part database, and at least one instruction to create a station layout for a steel fabrication facility. The computer-readable program code may further include at least one instruction to receive digital models of a plurality of buildings, each including a steel frame having beams and columns connected by full moment collar assemblies, and at least one instruction to parse the received digital models to generate a list of parts in the plurality of buildings as defined in the part database. The computer-readable program code may further include at least one instruction to generate routes and stages for the beams, the columns, and the components of the full moment collar assemblies through the stations of the steel fabrication facility, and at least one instruction to modify the digital model of at least one of the plurality of buildings to improve efficiency of the generated routes and stages.

In some examples, a data processing system for project management of building construction may include a server hosting a program configured to receive a plurality of digital building models and generate a list of parts in the digital building models, the list including beams, columns, and beam-column connection assemblies, and a computer in communication with the server over a network, a web browser on the computer executing a graphical user interface of the program. The program may include a database having an index of parametrically defined part types including components of each part type, historical fabrication data for each part type, an inventory of currently stored parts, and material pricing. The program may further include a fabrication module configured to define a fabrication capacity of one or more fabrication facilities, and a production module configured to generate a production plan for all parts of the generated list of parts, according to the historical fabrication data for the corresponding part types, the inventory, the material pricing, and the defined fabrication capacity.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a schematic diagram of an illustrative steel building frame construction cycle management software system in accordance with aspects of the present disclosure.

FIG. 2 is a schematic diagram of data generation and exchange between selected modules of the software system of FIG. 1, prior to award of a project.

FIG. 3 is a schematic diagram of data generation and exchange between selected modules of the software system of FIG. 1, subsequent to award of a project.

FIG. 4 is a schematic diagram of data generation and exchange between selected modules of the software system of FIG. 1, for creation of a production plan based on multiple projects.

FIG. 5 is a schematic diagram of an illustrative data processing system suitable for use with aspects of the present disclosure.

FIG. 6 is a schematic diagram of an illustrative distributed data processing system suitable for use with aspects of the present disclosure.

### DETAILED DESCRIPTION

Various aspects and examples of a construction cycle management software system, as well as related interfaces, programs, and methods, are described below and illustrated in the associated drawings. Unless otherwise specified, a software system in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Overview; (2) Examples, Components, and Alternatives; (3) Illustrative Combinations and Additional Examples; (4) Advantages, Features, and Benefits; and (5) Conclusion. The Examples, Components, and Alternatives section is further divided into subsections A through C, each of which is labeled accordingly.

### Overview

In general, an integrated budgeting, fabrication, and construction management software system may include a database, a plurality of modules, and a user interface. The modules may be designed to facilitate and automate planning, review, and management of multiple aspects of a set of building projects. For example, the plurality of modules may include an estimating or bidding module, a budgeting and/or project management module, a pricing and/or purchasing module, a production and/or fabrication module, a shipping and/or inventory module, and a construction and/or field module.

The plurality of modules may exchange information via project files and production plan files stored on the database. A project file may include building models, estimates, budgets, part lists, assembly lists, fabrication schedules, change orders, and/or transmittals. A production plan file may include multi-project part lists, assembly lists, fabrication capacity allocation, manufacturing plans, materials lists, and/or individual project design changes. The database may further store non-project specific data to be shared between modules. For example, the database may store purchase orders, historical pricing records, facility specifications and layouts, manpower allocations, and/or inventory storage capacity.

The software system may be configured to allow integration with external software. For example, the system may be configured to receive and interpret model files from Building Information Management (BIM) software such as Tekla Structures. For another example, the system may be configured to export staging information in a file format accepted by Manufacturing Execution System (MES) software or fabrication software such as Tekla PowerFab.

The software system may be configured to interpret each building component as one of a set of parametrically defined parts and assemblies thereof. Parameter values may be used to estimate fabrication time, cost, facilities or equipment needed, storage space, etc. The system may support user input of new parametrically defined parts and/or assemblies, definition of relevant parameters, and input of parameter values. Such configuration may significantly simplify incorporation of proprietary components and/or use of specialized technologies. The software may also be configured to track each building component by an assigned unique identifier, such as a serial number.

Aspects of the disclosed software system may be embodied as a computer method, computer system, or computer program product. Accordingly, aspects of the method and/or system may take the form of an entirely hardware example, an entirely software example (including firmware, resident software, micro-code, and the like), or an example combining software and hardware aspects, all of which may generally be referred to herein as a “circuit,” “module,” or “system.” Furthermore, aspects of the method and/or system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these.

Program code embodied on a computer-readable medium may be transmitted using any appropriate medium, including but not limited to wireless, wireline, optical fiber cable, RF, and/or the like, and/or any suitable combination of these. Computer program code for carrying out operations for aspects of the method of steel building frame construction cycle management may be written in one or any combination of programming languages.

Aspects of construction cycle management software systems are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s). In some examples, machine-readable instructions may be programmed onto a programmable logic device, such as a field programmable gate array (FPGA).

### Examples, Components, and Alternatives

The following sections describe selected aspects of exemplary steel frame building construction cycle management software systems as well as related interfaces, programs, and methods. The examples in these sections are intended for illustration and should not be interpreted as limiting the entire scope of the present disclosure. Each section may include one or more distinct examples, and/or contextual or related information, function, and/or structure.

### A. Illustrative Software System

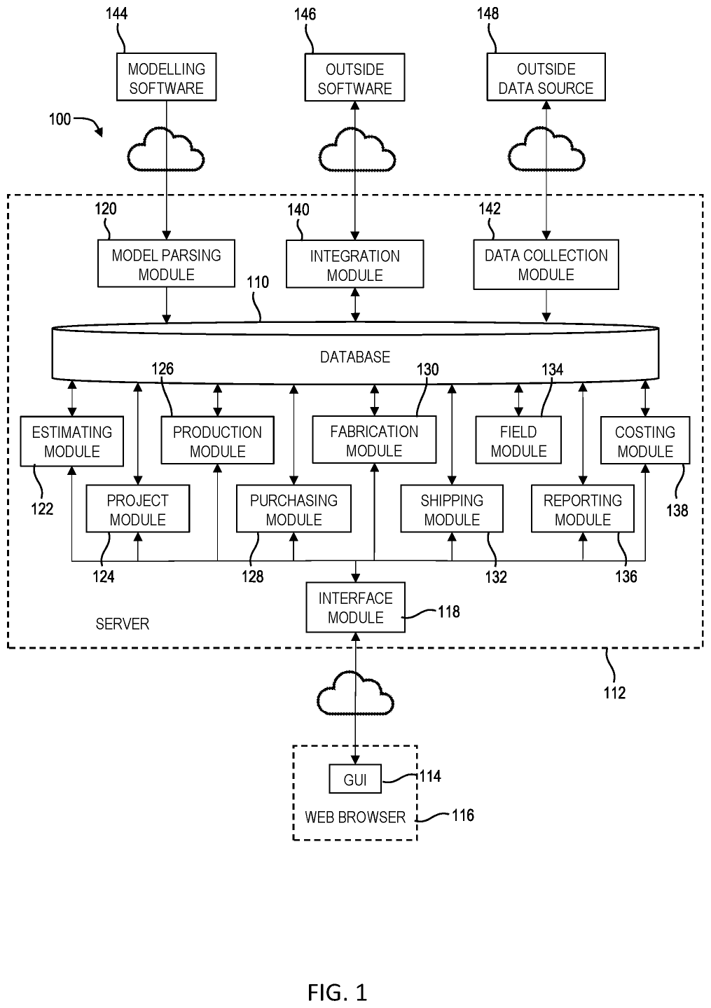

As shown in FIGS. 1-4, this section describes an illustrative steel building frame construction cycle management software system 100. System 100 is an example of integrated budgeting, fabrication, and construction management software, as described above.

System 100 includes a plurality of modules and a database 110, housed on a server 112. The system is accessible to a user through a graphical user interface (GUI) 114 executed by a web browser 116 of a local computer. The web browser of the local computer is in communication with an interface module 118 of server 112 over a network, such as a local area network (LAN) or the internet. GUI 114 for a single user is depicted in FIG. 1, but any number of users that can be accommodated by server 112 may access system 100 simultaneously.

The user of GUI 114 may have a profile in system 100 and access the system with assigned credentials. Access to modules of system 100 and/or features of one or more modules may be assigned to the user's profile, restricting the user to system functionality related to their role. The user may access their profile and the assigned system functionality from any browser with access to the server over a network.

In the present example, system 100 includes a Model Parsing Module 120, an Estimating Module 122, a Project Management Module 124, a Production Module 126, a Purchasing Module 128, a Fabrication Module 130, a Shipping Module 132, a Field Module 134, a Reporting Module 136, a Costing Module 138, an Integration Module 140, and a Data Collection Module 142. The modules exchange data via database 110. In general, the system may include some or all of the depicted modules, and/or may include additional modules with other functionality. In some examples, the system may include equivalent functionalities divided among different modules and/or with a non-modular architecture. In some examples, two or more modules may exchange data directly.

Modules of system 100 may be used by different departments of a construction company or organization and/or by different companies or organizations collaborating on a construction project. Drawings, budgets, purchase orders, fabrication schedules and other files or documents associated with a project or a production plan, created by a module and accessed by other modules, may include status indicators such as ‘provisional’, ‘revised’, ‘approved’, and ‘finalized’ to facilitate communication between departments or organizations.

Features, sub-modules, and functions of modules 120, 122, 124, 126, 128, and 136 are described in greater detail below. In the present example, system 100 and the modules are configured for steel frame building construction, specifically using a portfolio of proprietary column and beam connections. For example, full moment connection collars as described in U.S. Pat. No. 11,236,501 may be used. Fabrication may be performed with proprietary equipment such as that described in U.S. Patent Publication No. 2019/0247963, U.S. Patent Publication No. 2019/0247962, and/or U.S. Pat. No. 11,040,419.

Each connection may require fabrication of component parts and assembly of the components into collars or other assemblies. Steel members such as columns and beams may be purchased and/or manufactured. Connection components and/or assemblies may be attached to the columns and beams. Each member and each component may be individually tracked throughout system 100 by a unique mark number, or serial number. Assemblies of components and/or members with individual mark numbers may be further assigned an assembly mark number for tracking.

System 100 may be designed and/or configured to interface or integrate with modelling software 144 and/or outside software 146. Model parsing module 120 and integration module 140 may be updated and/or modified according to the specific software selected and changes in the selection. For example, model parsing module 120 may be configured to process building data from one or more BIM programs, such as Autodesk Revit, or Tekla Structures. For another example, integration module 140 may be configured to facilitate export of staging data from production module 126 to fabrication software such as Tekla PowerFab.

For another example, the integration module may be configured to facilitate export of cost codes from costing module 138 and purchase orders from purchasing module 128 to accounting software such as QuickBooks. For another example, the integration module may be configured to facilitate import of fabrication and/or construction man-hours to project management module 124 from time-keeping software. In some examples, individual modules may be configured to independently interface with outside software.

Data collection module 142 may facilitate input of relevant data from other sources, such as an outside data source 148. For example, the module may be configured to retrieve daily steel index updates to improve cost estimation. For another example, the module may be configured to export historical project data such as pricing, estimated versus completed project costs, change orders, and/or projected versus final fabrication schedules to a machine learning resource. The module may facilitate interface with the machine learning resource to receive relevant predictions based on the historical data, for use in project budgeting and planning.

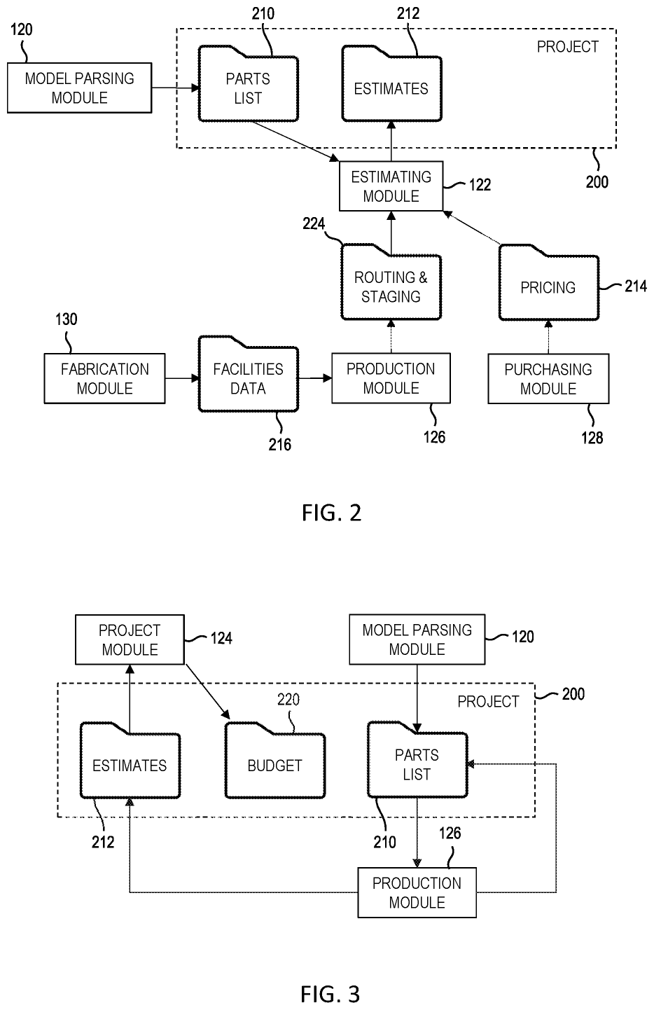

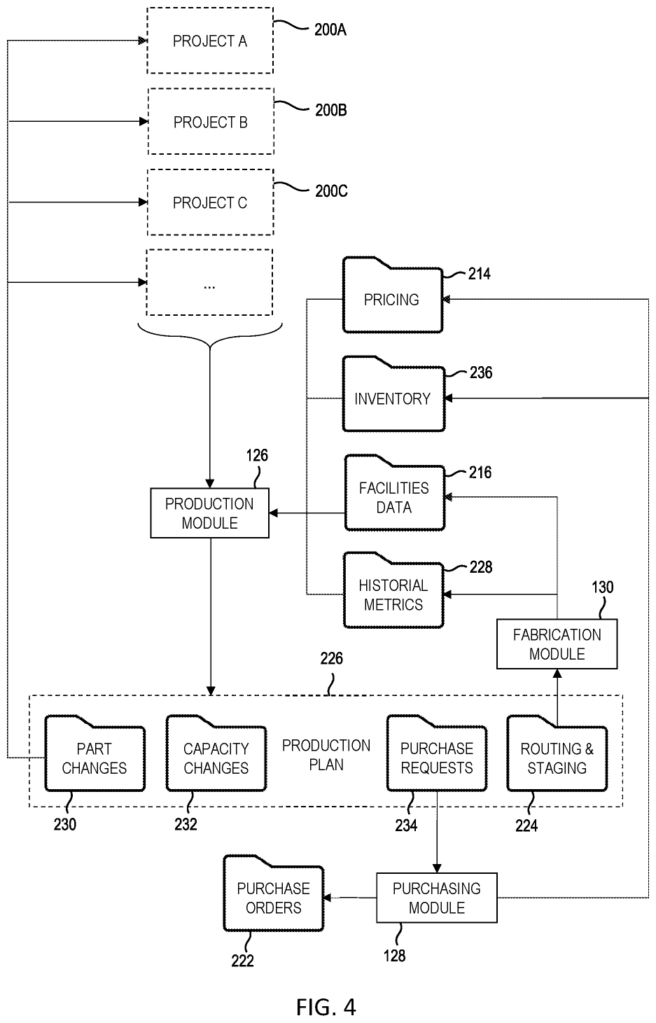

FIGS. 2-4 are schematic diagrams of data generation and exchange between modules during different phases of a building project. FIG. 2 depicts a bidding or pre-award phase focused on project estimates. FIGS. 3 and 4 depict a planning and production phase, post-award. FIG. 3 is focused on an individual project flow, while FIG. 4 depicts a multi-project production flow.

As shown in FIG. 2, for each project one or more digital models are uploaded to the system using model parsing module 120. The module may extract from each uploaded model needed information such as a parts list 210, drawings, and NC files. The uploaded model and extracted information including parts list 210 are associated with a project file 200. As revisions to the project design are made, revised models may be uploaded and added to project 200. The project may therefore include multiple historical iterations of each data set. A ‘current’ or ‘working’ parts list 210 and/or model may be indicated in project file 200.

Estimating module 122 may be used to generate one or more estimates 212, also associated with project 200. An estimate may be at least partially automatically generated by module 122 based on a current parts list 210, and costs calculated from stored information. Estimating module 122 may pull information for cost calculation from a database of parts and historical pricing 214, automatically generated routing and staging 224, and field data. As explained further with reference to FIG. 4, in some examples, routing & staging 224 and/or pricing 214 may be calculated based on a multi-project production plan.

Parts and pricing database 214 may be maintained through purchasing module 128, by purchasing and/or accounting users. The database may store historical pricing information for cost calculation, price lists from multiple suppliers, volume-based pricing structures, and/or any relevant pricing information. In the present example, the database also stores parametric part and assembly definitions, as defined by system users. For instance, the database may store a list of full moment collar connections such as the ones disclosed in U.S. Patent Publication No. 2019/0249409, the entirety of which is hereby incorporated by reference for all purposes. For each collar, the database may store the individual collar components. For each component, the database may store values for parameters such as weld length, bolt holes, raw material requirements, fabrication cycle time, and/or any other relevant information. In some examples, parametric part and assembly definitions may be stored separately and/or associated with another module.

Routing and staging 224 for project 200 may be automatically generated by production module 126 based on facilities data 216, which may in turn be generated and maintained through fabrication module 130. The fabrication module may allow users to input and edit stations, layouts, manpower shifts, equipment, and/or any information relevant to fabrication cost and schedule. The module may also allow simulation of station usage for cost calculation. In some examples, the fabrication module may be configured to import relevant data from files shared by sub-contractors or partner businesses. In some examples, field data used in cost calculation may be similarly generated and maintained through the field module, and include any and all information relevant to building erection and other work in the field.

In some examples, estimates 212 may be calculated according to current pricing, facility, and field data. In some examples, estimates 212 may include calculations such as suggested margins or total cost adjustments based on historical data. In some examples, estimates 212 may be calculated based on project design changes received from a multi-project production plan. In some examples, estimating module 122 may also include information from outside sources and/or other stored data in cost and/or schedule estimates.

Once a bid is won or and/or a project approved, as shown in FIG. 3, an approved parts list 210 may be accessed by production module 126 to plan fabrication and procurement of needed parts and materials. The production module may use facilities, inventory, pricing, and historical data with parts list 210 to plan out efficient fabrication and materials procurement. In some examples, production module 126 may generate changes to parts list 210 and/or a revised estimate 212.

Project management module 124 generates a budget 220 based on an estimate 212 associated with project 200, and related user selections. As the project progresses and revised models are uploaded, corresponding revisions may be made to budget 220. The project management module may generate change orders as revisions to parts list 210 and/or estimates 212 are made and implemented in budget 220.

As shown in FIG. 4, production module 126 may access data from multiple projects 220A, 200B, 200C, as well as data from fabrication module 130 and purchasing module 128, to generate an overall production plan 226. A user may select some or all project files to include in plan generation. In some examples, the production plan may be automatically generated by the production module, and a user may edit or amend the plan as appropriate. In some examples, relevant data may be presented to a user in routing and staging sub-modules, and a planning tool such that the user can formulate the production plan.

From each project, production module 126 may access data parsed from an approved model, including a parts list. Using a combined parts list from all included projects, the production module may automatically generate routing and staging 224 for all parts. The routing and staging may be generated using facilities data 216 determined by fabrication module 130 with the parts list and user created routing logic rules to plan out efficient fabrication. For example, facilities data 216 may include an inventory or record of all tooling and fixtures in operation for a given connection type, and a user may specify a logic rule requiring fabrication of all parts using a given fixture in a single stage.

In some examples, production module 126 may also use historical metrics 228 produced by fabrication module 130 based on recorded metrics from completed projects. For example, historical metrics 228 may include recorded man hours associated with fabrication of a specific part type, or may include an average of time over-estimate for a given fabrication facility.

Production module 126 may also access pricing 214 and inventory data 236 to generate production plan 226. The production module may account for materials, pre-fabricated components, or assemblies either currently on hand or projected to be surplus. Pricing structures such as volume discounts or rush fees may be incorporated from pricing data 214. Both pricing and inventory data may be maintained or accessed by purchasing module 128. For example, the purchasing module may be configured to integrate with outside inventory software and/or import .CSV format price lists.

In some examples, production module 126 may perform an analysis of procurement options for structural members in addition to fabrication planning. For example, the production module may select the most efficient option for the structural members of the combined projects part list, between: ordering to length from a supplier, placing a mill order for pre-set lengths and cutting to size, or a large volume roll-to-order mill purchase. The production module may include material cost, material waste, and/or labor cost.

Production module 126 may also generate part changes 230 to improve fabrication efficiency. Suggested changes may be automatically generated and approved by a user, and/or changes may be input by the user. Part changes 230 may include changes to column or beam sizes, collar types, and/or any structurally equivalent substitutions. Any part changes are then implemented in an updated model and part list for the relevant projects upon approval of production plan 226. For instance, part changes may be saved in the project file and flagged for a structural engineer to implement in the building model.

In an illustrative example, project 200A may include a large number of a first collar type which is fabricated on a first fixture set, while project 200B may include a small number of a second collar type which is fabricated on a second fixture set. While the first collar type may have a higher strength rating and be more expensive to produce per part than the second collar type, it may be that fabricating all collars of the first type in a single stage is more cost effective than a fixture change for a small stage of the second collar type. In such an example, part changes 230 would include a substitution of the first collar type for the second collar type in project 200B.

In another illustrative example, project 200C may include the second collar type, but a sufficient number of the first collar type may be left over in inventory due to a change order on a previous project. In such an example, part changes 230 would include a substitution of the first collar type for the second collar type in project 200B to save on fabrication costs.

Some production plans 226 may include capacity changes 232. For example, when a required set of parts cannot be fabricated in a required time frame, fabrication of additional fixtures may be ordered and additional facilities acquired or contracted to fabricate the parts.

Production module 126 may output final routing and staging data 224, which may be exported to outside fabrication software 146 for execution. The staging data may include shop drawings and NC files from the individual project files. Routing and staging data 224 may also be accessed by fabrication module 130, to generate a fabrication schedule. The fabrication module may allow oversight and/or review of ongoing production, for example displaying comparisons of allocated man-hours from budget 220 and current totals of hours logged so far on the project. In some examples, such review may additionally or alternatively be accessible through the project management module. Comparisons of budgeted and actual costs may be displayed according to cost codes defined in the costing module.

Production module 126 may generate internal purchase requests 234 for materials needed for fabrication and construction, which may be passed to purchasing module 128. Through the purchasing module, the purchasing department may review and approve the requests, select appropriate vendors, and generate purchase orders 222.

### Model Parsing Module 120

Model files prepared in outside software are saved for upload in a specialized format using a submittal tool such as a plug-in or add-on for the software. When a user uploads such a file into the system, a pop-up may appear to verify key information for downstream parties, including submittal type and approval status. The user also selects an existing project to add to, or creates a new project.

The user may confirm the submittal type to verify the package being uploaded is the correct file. This includes ESTIMATE, ABOM, IFA, RFA, IFC, RFC. The user will then issue an approval status to let downstream parties know what the model data can be used for. This includes preliminary forecasting, pricing/sourcing, released to purchase, released for fabrication.

After the user verifies the upload, a pop-up will appear showing the drawings and computer aided manufacturing (CAM) files such as NC files, uploaded to date from all previous upload history. It will include a date uploaded to let the user know if and when drawings have been revised.

The model uploader enables all users to view the model version history uploaded as well as the drawings and NC files for that project. To review the content that has been uploaded, the user selects the relevant project and the model version history will appear as well as all drawings and NC files. Drawings may be viewed as a PDF in a separate window.

### Estimating Module 122

The estimation module may be used by members of a sales team to produce estimates and bids to secure projects. The module may produce estimates based on digital or building information management (BIM) models uploaded using the model parsing module and associated to a project. Estimates for a project may be revised in response to updated models, or as appropriate for bidding.

To create an initial estimate, a project will first need to be created and an associated model uploaded using the model parsing module. In a pop-up the user names the estimate and selects a default configuration setting to be used, which will include: default material pricing (from specific vendors) and default fabrication metrics (shop layout/production simulations/buffers). The user then selects the model version and the upload information for that model is displayed.

After all of the metrics have been finalized, the user can generate the estimate. The material engine and fabrication engine outputs can be viewed prior to generating an estimate, as described below. After the estimate is generated, a ‘total cost’ will be displayed.

The user can also create custom configurations on the fly to see various scenarios. When a new configuration is created, the configuration can be saved to the database for future use. Some costs will automatically be generated and populated based on stored data when the estimate is created. Such costs may include material and fabrication costs for registered parts. Costs for custom parts or costs not generated by the system can be manually entered by the user. Each manual input will update the ‘total cost’ value.

When all costs are accounted for on the estimate, the user can update the baseline contract value to a desirable scenario and the total margin will populate based on that value. Finally, the user may save to store the estimate data into the database.

After an estimate is created, there may be additional model updates before fabrication. To create new estimates and/or budgets to reflect the new model data, a new estimate can be created from a new model version. The user creates a new estimate and selects the latest model version available on the drop down menu. After selecting the new model version, a pop-up will provide a choice whether or not to carry over previous estimation data.

Carrying over previous estimation data will carry over the baseline margin initially assigned to the project from the previous estimate. As a result, when the new budget is created from the new estimate, the baseline margin will remain the same as the initial estimate for traceability and potential cost mitigation. If the project has not been awarded and the user is revising a bid to the client, it may be appropriate not to carry over previous estimation data. Original baseline margins will not be considered and the created estimate will be a completely new estimate.

The various configuration settings can be selected to create various bids or estimates with different scenarios. The settings can be selected from a drop down menu and applied to show revised outputs. The user can create new configuration settings and/or modify the different metrics defaulted.

The default material metrics used when generating estimates can be adjusted to see various ‘default’ vendors or ‘altered material margin’ scenarios to see the impacts to the bottom line. This can be done through the material engine, as discussed below. The default fabrication metrics used when generating estimates can be adjusted to see various fabrication scenarios and the impacts to the bottom line. This can be done through the fabrication engine, as discussed below. In the present example, the material engine functions are performed through the purchasing module and the fabrication engine functions are performed through the production modules.

The default fabrication facility can be adjusted to reflect different facilities as defined in the facility module. The default facility layout can be adjusted to reflect different shop layouts, man power utilization, different burden rates, etc. (e.g. for overtime rates). The default station capacity simulator can be adjusted for various building types based on simulations stored on the database. Simulations may characterize building categories to accurately reflect the production metrics based on the building information modeling (BIM) data. Some building ‘category’ examples include: building type, connection system, moment beam size, and route complexity. In some examples, simulations may include concurrent fabrication of multiple projects.

The default facility metrics used when generating estimates can be adjusted to add buffers to labor-driven fabrication cost codes and adjust the critical path percentages for schedule-driven fab cost codes. This can be done thru the fabrication engine, as discussed below.

The default field metrics can be adjusted to reflect field conditions, such as available equipment, man power, and schedule constraints. The default field metrics used when generating estimates can be adjusted to see various construction scenarios and the impacts to costs. This can be done through the field module.

In some examples, the user may need to or may opt to manually input data for estimates. For example, the user may manually input field rates and field hours if the field module is not used.

Filters can be used to filter cost codes on the estimating module. (e.g. shop-labor, field). New filters for cost codes can be added in the cost code module by editing the label fields associated to each cost code. New labels can be added in the label field of a relevant cost code.

Various outputs on the estimating module are exportable in a .CSV format, for internal or external coordination as needed. A download button is included for each such output. All outputs produced from the estimation module can be manually changed by the user, by clicking within the table fields to edit. Changes to the estimate must be saved after such manual edits.

With each estimate created, the estimating module enables the user to see in-depth data analysis with the material engine and fabrication engine.

There is a material summary table in the material engine that summarizes pricing information based on user defined material categories. Material categories can be assigned to specific parts in the cost code, by part mapping within the costing module. Each material category (beams, columns, collars etc.) on the material summary table can be assigned a specific margin or buffer, for optimum flexibility with pricing for a particular project. The material engine displays material cost pricing based on the configuration settings loaded. These settings can be used to fine tune estimates and bids.

The total material cost output on the material engine can be adjusted to price material for a project based on the default vendors selected for each material category. Depending on the default vendors selected, if a price does not exist for that vendor, the estimation module will retrieve the latest price assigned for that part profile from the database. If a price does not exist, pricing information may be added through the purchasing module.

The material engine allows users to see the registered parts in the uploaded model, along with other useful metrics to understand how the estimate and material summary metrics are being produced. Unregistered parts are also displayed, to allow the user to register new parts to the database so the parts can be accounted for when new estimates or budgets are created. A vendor and unit price may be assigned to newly registered parts through the purchasing module. Multiple vendors and/or prices can be added for a part.

Each saved facility layout in the production module can be chosen to calculate various estimates and see the bottom line impacts based on the facility layout (man power, station quantity, burden rates, etc.) Each saved station capacity simulation can be chosen to produce accurate fabrication hours and overall schedule duration based on model complexity, part type, etc.

Each time a model is uploaded, the user can run various fabrication simulations based on the saved facility layouts and station capacity simulations. Once the metrics are selected, the user can view high level fabrication metrics and see the impacts in cost and schedule.

The fabrication engine can display total fabrication hours for a project by individual shift or an accumulation of all shifts. The preferences can be adjusted to add buffers to labor driven station outputs, and/or to select critical path stations. When critical path stations are selected, the schedule driven station calculations will be generated based on those station schedule duration's and the percentage of the schedule entered.

Status of a project may be designated. This may isolate model data of non-awarded projects from being viewed in other modules.

### Project Management Module 124

The project management module may be used by members of a project management team, and can be utilized throughout the entire lifecycle of projects. As the project model is updated with design changes, project managers can keep track of building costs relative to budgeted amounts in real-time. See below for other features included. A budget may be generated based on an estimate created in the estimation module.

The project management module pulls the latest pricing in the pricing database, as entered through the purchasing module. The pricing can be locked when the material has been secured for a specific project. Facility metrics can be reconfigured to calculate various cost estimates and see bottom line impacts based on different fabrication scenarios. Fabrication metrics used in the budget may be changed by creating a new estimate.

Change orders can be created as changes progress throughout the project life-cycle. The change order “type” feature allows the user to distinguish between internal changes (for which costs are not billed) and external changes (for which costs are billed to the client).

With each model upload, the user will have the option of updating their budget to reflect the current model's material and fabrication cost. To update the budget to reflect the current model, the user creates a new estimate based on the new model, then creates a budget from the revised estimate. When creating a new estimate, the user will be asked whether to carry over data from previous estimate. Carrying over the data may allow the baseline budget to be tracked. The baseline margin is also tracked when the data is carried over.

Change orders can be created in the revised estimate. When the budget is created from the revised estimate, the change order data can also be transferred. With each model revision, the user can either confirm or deny changes for each cost code that is affected.

The margin tracker in the results tab will keep track of the baseline margin compared to the current cost of the building. An arrow pointing upward will be displayed as long as the current margin is equal to or greater than the initial margin assigned in the estimating module. If the margin is lower than the baseline margin, the arrow will point downward.

All outputs of the project management module are exportable in a .CSV format, for internal or external coordination as needed. A download button is included for each output. All outputs produced from the project management module can also be manually changed by the user, by clicking within the table fields to edit. Changes to the budget must be saved after such manual edits.

### Purchasing Module 128

The purchasing module may be used by members of an accounting and/or purchasing team. The module includes a historical pricing database, and in some examples may include a purchasing feature configured to automatically generate purchase orders based on a material list or purchasing requests from the production module.

The pricing database stores pricing history for all part profiles registered into the system. The pricing data is then used to produce material costs for the estimating and project management modules. Users can view price history for existing parts, in a material pricing graph. The price graph can show pricing from all vendors for comparison. The entire pricing database for all registered parts can be downloaded through the interface, to allow use with other software and/or manual analysis.

There are two ways to update pricing through the purchasing module, through the interface or by uploading a pricing file. For the first, the user can select an edit button, filter a parts list, select parts to updating pricing for, then click an ‘add pricing button’. To upload a file, the user may prepare a .CSV according to a required data structure, and then select an ‘import file’ button in the interface to access a file browser.

Users can view all current and previous pricing history for all registered parts with pricing. Text filters are included, and allow the list of parts to be filtered by profile, vendor, and/or part name. When parts are selected from the table, an option to display the price history in the material pricing graph appears.

Some parts may be registered without pricing, for example may be registered through the estimation module, or production module. Users can assign pricing to such parts through the purchasing module. Once parts are registered, users can assign the following: price per unit, UOM, vendor & currency. Users can assign pricing metrics to multiple items at once for convenience. The user may select multiple parts in the list, and then use drop-down arrows next to the table headers.

### Production Module 126

The production module may be used by members of a production or fabrication team to plan routing and staging of all parts for a project. The production module includes three sub-modules: routing, staging, & purchase requests. The production module is described below in reference to a single project, but in some examples may perform the same functions for a selected group of projects.

Once a model is uploaded for a project, the production module auto-routes the assemblies and small parts based on database part mapping. The production module then stages assemblies based on actual station capacities to generate fabrication days for the shop. The production module then creates purchase requests based on the list that the staging sub-module produced. Staging information is then exported to external fabrication management software.

The routing sub-module has two parts, the routing database with all of the possible routes for an assembly and the project data feature which predicts optimal routes based on the project info that has been uploaded.

Using the project data feature, the user can register new parts, verify & edit station part mapping, and run automated assembly routing based on the current model for a project and the routing database configuration. Users can revise routing set up or add new routes if desired.

On the register parts tab, the user can register any new parts from the model to the database so the parts can be priced and routed to specific stations to enable routing automation in the future. The tab may include an auto-register button to automatically register all un-registered parts in the model. Station part mapping at the project level enables users to direct newly registered parts to specific stations to produce routes. Routing all parts to stations may ensure that the station capacity simulator includes all part routes for accurate simulations.

In some examples, the routing sub-module may calculate weld points and bolt points to generate an output for each project. Weld points and bolt points may be used to determine the complexity of the assemblies to produce different routes through the shop. Weld points may be calculated based on the length of the welded part being welded to the assembly. Bolt points may be calculated based on the total hole quantities on the connecting members (e.g. 1 bolt hole=5 bolt points). The station capacity simulator can be adjusted to account for variable weld calculations and/or variable bolt calculations.

In some examples, parametric values associated with each part may be used to produce routes through the shop. For instance, a number of weld points and bolt points may be associated with each part when a new part is created.

The user can run the station capacity metrics report in the reporting module to see the weld and bolt points for assemblies. Weld point or other metrics for assemblies may also be viewable with the station capacity simulator metric report within the reporting module. Metrics may also be viewable on a routing output tab of the production module.

The routing database can be updated to add or revise routes, route modifiers, part station mapping and the available stations within a facility. To produce new routes, the user needs to create the required stations within the stations tab if they do not exist. A route map includes the route code, route name, and the order of stations included in that route. Route modifiers are logical rules used to output custom routes based on specific data points in the model, such as weld points. User can define and adjust the variables of a routing modifier that drive the beam and column routing outputs.

The part station mapping is used to determine an assembly route based on the parts within the assembly. The parts are all individually routed to each station. If automatic assembly routing outputs are incorrect, the user can adjust the part mapping by selecting an incorrect station and designating a replacement.

Labor driven stations are used to create routes and enable the station capacity simulator to output station capacities based on the current project model. Schedule driven stations are used to produce fabrication hours for those cost codes based on the automated fabrication schedule produced in the production module. The user can add or edit either type of station.

The staging sub-module has two parts, a planning feature for assemblies that require staging and a staged feature for items that have already been planned & staged. The staging sub-module can be run after the user has verified the routing output from the routing sub-module for a project, and ensured all assemblies have been routed correctly through the facility. Once stages are created, the staging sub-module gives a schedule duration of the stage for the master fabrication schedule.

The planning feature gives users the ability to group approved assemblies together with much more control and visibility without having to review shop drawings. To create a stage from the approved steel, the user selects a facility layout. This helps determine man power, shifts, shift hours, and number of stations, which all affect schedule duration. The user then selects a simulation, and simulator capacities are automatically loaded. Finally, the user selects assemblies to stage.

The planning tool also displays a summary and efficiency metrics, which gives the user the ability to see their planned stage and verify that the shop is fully utilized with optimum efficiency based on the current station capacities for the project. In some examples, the planning tool can display a summary and efficiency metrics for multiple projects within a facility, allowing the user to most efficiently utilize station capacities.

The staged feature gives the users the ability to view and edit created stages. If a staged assembly has been changed, the user can remove the assembly from the stage. Once the stage is confirmed, and the purchase request is created for the stage, the user can export the staging data to outside fabrication management software, such as Tekla EPM. Drawings and NC files can be included with the data export. Members that have been previously staged, but modified in the most recent export may be indicated by a revised stage icon. Stages can be updated an re-exported to update shop drawings.

The purchase request sub-module enables the user to create purchase requests based on the stages created. The user can produce automated purchase request packages. All created purchase requests are compiled in a central location for transparency. The created purchase requests contain all selected assemblies during the staging process as well as the single parts included with those members. The user can also add new purchase requests on demand.

After a purchase request is created, the user can assign material categories to the individual parts. Parts can be mass categorized or individually categorized into categories to compile automated purchase request deliverables. Text filters can be applied to isolate members and assign categories to multiple parts at once. Once all parts within a purchase request have be categorized, the user can download a .ZIP format file containing relevant drawings and NC files. Each material category is separated into individual sub-folders within the .ZIP file.

### Fabrication Module 130

The fabrication module may be used by members of a production or fabrication team to plan facility stations and layouts, simulate station capacities for projects, and generate project fabrication schedules. The fabrication module includes four sub-modules: dashboard, facility, station capacity simulator, and facility planning engine.

Based on the stages generated by the production module, the fabrication module auto-generates a schedule. A master schedule is displayed in calendar and list views in the dashboard, and can be manually edited by a user. In some examples, the master schedule may include project schedules for multiple concurrent projects.

Progress of individual stages can also be viewed through the dashboard, by facility and/or by project. For each project, the number of each class of assembly may be displayed. A breakdown of assembly status may also be displayed, including: not released for production, released, staged, in fabrication, fabricated, and shipped.

In some examples, the fabrication dashboard may also display budget summary data, as related to fabrication. For instance, the dashboard may include summary data as displayed in the project management module, but only for cost codes related to fabrication such as: plant rental equipment, plant shop consumables, machine shop consumables, tooling and fixturing, cut and drill, supervision hours, and planning hours.

Budget summary data may include for each cost code: total budget, amount spent, percentage spent, remaining amount, forecasted amount required for project completion, and percent over or under budget. Budget summary data may also include distribution among codes, averages and/or totals for spending over time, and graphs or charts of relevant data.

The facility sub-module enables creation of facilities and entry of relevant facility information, including stations, routes, assets, and work force. A user may add and/or edit stations, including assigning a name, a cost code, and a type. The user may then define routes including one or more stations. Assets may include facility and/or station equipment such as fixturing, welders, cranes, forklifts, etc. A user may also add and/or edit employees, including assigning each employee to a facility, specifying actions the employee is qualified or approved to perform, and labor cost.

The station capacity simulator uses facility data to simulate station capacities for a project. The simulator may be used to generate a plurality of simulations, which can be stored on the database and accessed by other modules. Simulations may characterize building categories to accurately reflect the production metrics based on the building information modeling (BIM) data. Simulated station capacities for a selected project may be viewed in an interface of the fabrication module, and/or in an interface of a module accessing a simulation.

For each defined facility, the facility planning engine allows a user to create multiple layouts. Each layout may comprise one or more shifts, each shift including a selection of stations associated with the facility and assigned manpower for each station. The user may define daily hours and an hourly burn rate for each shift. In some examples, facility layouts may be defined according to current facility set-up and staffing, and used to plan staging and routing for multiple projects. In some examples, facility layouts may be project driven. In such examples, a facility layout may be defined and associated to each project.

### Reporting Module 136

The reporting module may be used to access selected data from uploaded models, in a useful format. In some examples, the reporting module may also be configured to generate reports based on other data from the system such as pricing history, inventory, or production efficiency. For instance, a change order report may be generated from estimates created in the estimation module and used by the project management module. Details of all change orders created may be listed and/or summarized in such a report.

Basic reports can be generated as models are uploaded throughout the modeling phase, to determine preliminary metrics for specific data for procurement and fabrication. All reports can be downloaded as .CSV format files, and/or displayed in the browser interface. Examples of basic reports include, but are not limited to: structural beam, structural column, structural assemblies frequency, main steel forecast, and small parts forecast.

Each report may be pre-defined and/or customizable. For example, a structural beam report may include by default: quantity, prefix, mark number, profile, length, route, hole quantity, slope, skew, camber, finish, sub-parts, and welded attachments. For another example, a small parts forecast for single parts attached to main steel assemblies may include by default: count, name, profile, material, length fraction, length decimal, piece weight, extended weight, and weight source.

Advanced reports can be generated from various model uploads throughout the detailing phase to keep track of certain information in project management. After a report is generated, the report output may be displayed in the browser interface, or downloaded as a .CSV format file. All reports may contain mark numbers for piece tracking, sequence, lots, approval status etc. Examples of advanced reports include, but are not limited to: assembly list, assembly summary, part list, part summary, and station capacity simulator metrics.

For example, an assembly list report itemizes assemblies per individual guide ID. Sub-assembly marks are excluded to ensure correct total tonnages. The report outputs the following data for itemized assemblies: guide ID, assembly mark, name, part profile, part length, assembly weight, weight source, material (main part), KSI, skew, slope, camber, finish, lot, phase, approval status, last submittal, and issued. For another example, a station capacity simulator metrics report displays assembly metrics needed to configure the station capacity simulator. The report displays assembly weld points & bolt points, and part weld points & bolt points within the assembly.

### B. Illustrative Data Processing System

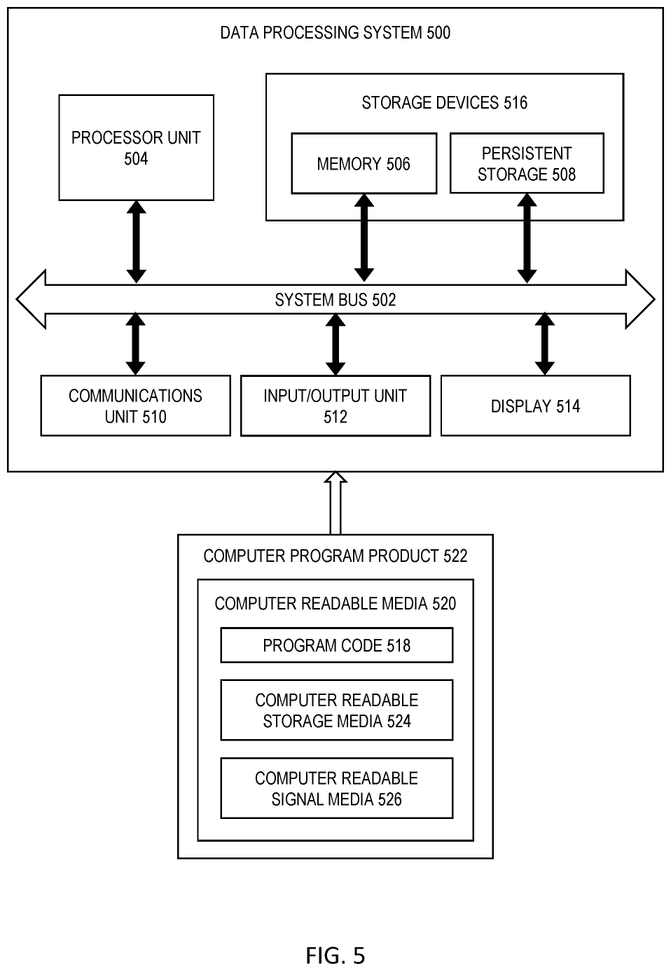

As shown in FIG. 5, this example describes a data processing system 500 (also referred to as a computer, computing system, and/or computer system) in accordance with aspects of the present disclosure. In this example, data processing system 500 is an illustrative data processing system suitable for implementing aspects of the method of detecting near-surface porosity. More specifically, in some examples, devices that are examples of data processing systems (e.g., laptops, tablets, personal computers) may be used to execute a software system as described above, and/or access a graphical user interface of the software system using a web browser.

In this illustrative example, data processing system 500 includes a system bus 502 (also referred to as communications framework). System bus 502 may provide communications between a processor unit 504 (also referred to as a processor or processors), a memory 506, a persistent storage 508, a communications unit 510, an input/output (I/O) unit 512, and/or a display 514.

Processor unit 504 serves to run instructions that may be loaded into memory 506. Processor unit 504 may comprise a number of processors, a multi-processor core, and/or a particular type of processor or processors (e.g., a central processing unit (CPU), graphics processing unit (GPU), etc.), depending on the particular implementation. Further, processor unit 504 may be implemented using a number of heterogeneous processor systems in which a main processor is present with secondary processors on a single chip.

Memory 506 and persistent storage 508 are examples of storage devices 516. A storage device may include any suitable hardware capable of storing information (e.g., digital information), such as data, program code in functional form, and/or other suitable information, either on a temporary basis or a permanent basis. Storage devices 516 also may be referred to as computer-readable storage devices or computer-readable media.

Persistent storage 508 may contain one or more components or devices. For example, persistent storage 508 may include one or more devices such as a magnetic disk drive (also referred to as a hard disk drive or HDD), solid state disk (SSD), an optical disk drive such as a compact disk ROM device (CD-ROM), flash memory card, memory stick, and/or the like, or any combination of these. One or more of these devices may be removable and/or portable, e.g., a removable hard drive.

Input/output (I/O) unit 512 allows for input and output of data with other devices that may be connected to data processing system 500 (i.e., input devices and output devices). For example, an input device may include one or more pointing and/or information-input devices such as a keyboard, a mouse, touch screen, microphone, digital camera, and/or the like. These and other input devices may connect to processor unit 504 through system bus 502 via interface port(s) such as a serial port and/or a universal serial bus (USB).

Output devices may use some of the same types of ports, and in some cases the same actual ports, as the input device(s). For example, a USB port may be used to provide input to data processing system 500 and to output information from data processing system 500 to an output device. Some output devices (e.g., monitors, speakers, and printers, among others) may require special adapters. Display 514 may include any suitable human-machine interface or other mechanism configured to display information to a user, e.g., a CRT, LED, or LCD monitor or screen, etc.

Communications unit 510 refers to any suitable hardware and/or software employed to provide for communications with other data processing systems or devices. While communication unit 510 is shown inside data processing system 500, it may in some examples be at least partially external to data processing system 500. Communications unit 510 may include internal and external technologies, e.g., modems, ISDN adapters, and/or wired and wireless Ethernet cards, hubs, routers, etc. Data processing system 500 may operate in a networked environment, using logical connections to one or more remote computers.

Instructions for the operating system, applications, and/or programs may be located in storage devices 516, which are in communication with processor unit 504 through system bus 502. In these illustrative examples, the instructions are in a functional form in persistent storage 508. These instructions may be loaded into memory 506 for execution by processor unit 504. Processes of one or more examples of the present disclosure may be performed by processor unit 504 using computer-implemented instructions, which may be located in a memory, such as memory 506.

These instructions are referred to as program instructions, program code, computer usable program code, or computer-readable program code executed by a processor in processor unit 504. The program code in the different examples may be embodied on different physical or computer-readable storage media, such as memory 506 or persistent storage 508. Program code 518 may be located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may comprise computer-readable storage media 524 or computer-readable signal media 526.

The different components illustrated for data processing system 500 are not meant to provide architectural limitations to the manner in which different examples may be implemented. One or more examples of the present disclosure may be implemented in a data processing system that includes fewer components or includes components in addition to and/or in place of those illustrated for computer 500. Other components shown in FIG. 5 can be varied from the examples depicted. Different examples may be implemented using any hardware device or system capable of running program code. In some examples, processor unit 504 may take the form of a hardware unit having hardware circuits that are specifically manufactured or configured for a particular use, or to produce a particular outcome or progress. This type of hardware may perform operations without needing program code 518 to be loaded into a memory from a storage device to be configured to perform the operations. For example, processor unit 504 may be a circuit system, an application specific integrated circuit (ASIC), a programmable logic device, or some other suitable type of hardware configured (e.g., preconfigured or reconfigured) to perform a number of operations.

### C. Illustrative Distributed Data Processing System

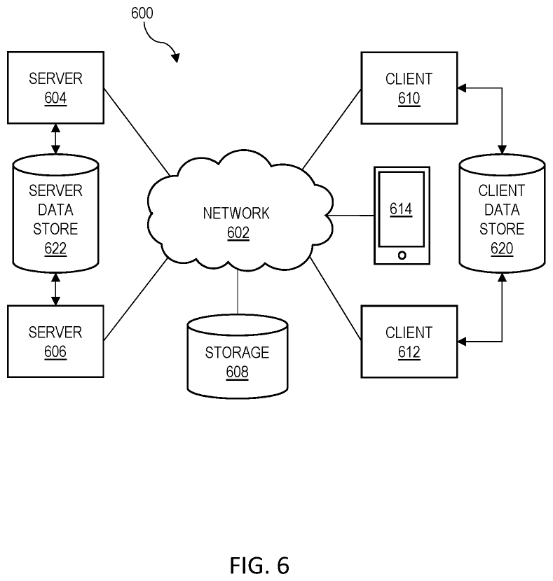

As shown in FIG. 6, this example describes a general network data processing system 600, interchangeably termed a computer network, a network system, a distributed data processing system, or a distributed network, which may be host and/or execute one or more elements of the above illustrative examples of steel frame building construction cycle management software systems. For example, the illustrative software system may be hosted on a network accessible server, may communicate with outside software over a network, and/or may be accessed by users from a web browser over a network.

It should be appreciated that FIG. 6 is provided as an illustration of one implementation and is not intended to imply any limitation with regard to environments in which different examples may be implemented. Many modifications to the depicted environment may be made.

Network system 600 is a network of devices (e.g., computers), each of which may be an example of data processing system 500, and other components. Network data processing system 600 may include network 602, which is a medium configured to provide communications links between various devices and computers connected within network data processing system 600. Network 602 may include connections such as wired or wireless communication links, fiber optic cables, and/or any other suitable medium for transmitting and/or communicating data between network devices, or any combination thereof.

In the depicted example, a first network device 604 and a second network device 606 connect to network 602, as do one or more computer-readable memories or storage devices 608. Network devices 604 and 606 are each examples of data processing system 500, described above. In the depicted example, devices 604 and 606 are shown as server computers, which are in communication with one or more server data store(s) 622 that may be employed to store information local to server computers 604 and 606, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 610 and 612 and/or a client smart device 614, may connect to network 602. Each of these devices is an example of data processing system 500, described above regarding FIG. 5. Client electronic devices 610, 612, and 614 may include, for example, one or more personal computers, network computers, and/or mobile computing devices such as personal digital assistants (PDAs), smart phones, handheld gaming devices, wearable devices, and/or tablet computers, and the like. In some examples, such client computers may include communications-enabled data processing systems on one or more automated fabrication systems connected to network 602. In the depicted example, server 604 provides information, such as boot files, operating system images, and applications to one or more of client electronic devices 610, 612, and 614. Client electronic devices 610, 612, and 614 may be referred to as “clients” in the context of their relationship to a server such as server computer 604. Client devices may be in communication with one or more client data store(s) 620, which may be employed to store information local to the clients (e,g., cookie(s) and/or associated contextual information). Network data processing system 600 may include more or fewer servers and/or clients (or no servers or clients), as well as other devices not shown.

In some examples, first client electric device 610 may transfer an encoded file to server 604. Server 604 can store the file, decode the file, and/or transmit the file to second client electric device 612. In some examples, first client electric device 610 may transfer an uncompressed file to server 604 and server 604 may compress the file. In some examples, server 604 may encode text, audio, and/or video information, and transmit the information via network 602 to one or more clients.

Client smart device 614 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 600 may be stored in or on a computer-readable storage medium, such as network-connected storage device 608 and/or a persistent storage 508 of one of the network computers, as described above, and may be downloaded to a data processing system or other device for use. For example, program code may be stored on a computer-readable storage medium on server computer 604 and downloaded to client 610 over network 602, for use on client 610. In some examples, client data store 620 and server data store 622 reside on one or more storage devices 608 and/or 508.

Network data processing system 600 may be implemented as one or more of different types of networks. For example, system 600 may include an intranet, a local area network (LAN), a wide area network (WAN), or a personal area network (PAN). In some examples, network data processing system 600 includes the Internet, with network 602 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 602 may be referred to as a “cloud.” In those examples, each server 604 may be referred to as a cloud computing node, and client electronic devices may be referred to as cloud consumers, or the like. FIG. 6 is intended as an example, and not as an architectural limitation for any illustrative examples.

### Illustrative Combinations and Additional Examples

This section describes additional aspects and features of software systems, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A method of constructing a building, comprising:

developing a digital model of a building including a frame structure having beams connected to columns by full moment collar assemblies,

uploading the digital model into a project management software tool including:
a cost estimating module,
a reporting module,
a budgeting module,
a fabrication module, and
a pricing database,

wherein:

the fabrication module determines fabrication logistics data for fabricating the full moment collar assemblies prior to shipping beams and columns to a job site, and

the cost estimating module calculates a total cost based on the uploaded digital model, historical pricing stored in the pricing database, and fabrication logistics data determined by the fabrication module.

B0. A computer implemented method of estimating a total cost for construction of a steel building frame, the method comprising:

defining a part database including beams, columns, and components of a full moment collar assembly,

storing historical pricing data for the parts in the part database,

creating a station layout for a steel fabrication facility,

receiving a digital model of a building including a steel frame having beams and columns connected by full moment collar assemblies,

generating routes and stages for the beams, the columns, and the components of the full moment collar assemblies through the stations of the steel fabrication facility,

calculating an estimated cost for the steel building frame based on the received digital model, the historical pricing data in the part database, and the generated routes and stages.

B1. The method B0, further including receiving a revised digital model of the building, calculating a revised estimated cost for the steel building frame based on the revised digital model, and generating a change order including a difference between the estimated cost and the revised estimated cost.

B2. The method of B0 or B1, further including receiving a revision to the generated routes and/or stages from a user, and in response calculating a revised estimated cost for the steel building frame.

B3. The method of any of B0-B2, further including adding a second full moment collar assembly and components of the assembly to the part database.

B4. The method of any of B0-B3, wherein defining the part database includes associating a plurality of parameters with each part in the database and storing a value for each parameter.

B5. The method of B4, wherein calculating the estimated cost for the steel building frame is also based on the stored parameter values.

B6. The method of B4 or B5, wherein the routes and stages generated for the beams, the columns, and the components of the full moment collar assemblies are based on the stored parameter values for each part.

B7. The method of any of B0-B6, wherein generating routes includes calculating all possible routes and selecting a most efficient route for each part.

C0. A data processing system for project management of building construction, comprising:

a server hosting a program configured to receive a digital building model, and

a computer in communication with the server over a network, a web browser on the computer executing a graphical user interface of the program,

wherein the program includes:

a pricing database having a listing of parts including all parts in the digital building model and historical pricing for each part,

a production module configured to route and stage the parts of the digital building model through the stations of a facility,

an estimation module configured to calculate an estimated construction cost based at least in part on the historical pricing for each part of the digital building model, and routing and staging of the parts from the production module, and

a reporting module configured to display and export data from the pricing database, production module, the estimation module, and/or the digital building model, and

wherein the parts in the pricing database include steel beams and columns, and components of full moment connection collar assemblies.

C1. The system of C0, wherein for each part in the pricing database, values for a plurality of parameters are stored in the pricing database.

C2. The system of C1, wherein the parameters include weld length and number of bolt holes.

C3. The system of any of C0-C2, wherein the parameters include a quantitative measure of fabrication complexity.

C4. The system of any of C0-C3, wherein the pricing database includes both a full moment connection collar assembly and each component of the assembly.

C5. The system of C4, wherein the estimation module calculates the cost of the full moment connection collar assembly based on a materials cost and a fabrication cost for each component of the assembly.

C6. The system of any of C0-05, further including a budgeting module configured to generate a budget based on an estimate calculated by the estimation module.

D0. A computer implemented method of managing construction of a steel building frame, the method comprising:

defining a part database including beams, columns, and components of a full moment collar assembly,

storing historical pricing data for the parts in the part database,

creating a station layout for a steel fabrication facility,

receiving digital models of a plurality of buildings, each including a steel frame having beams and columns connected by full moment collar assemblies,

parsing the received digital models to generate a list of parts in the plurality of buildings as defined in the part database,

generating routes and stages for the beams, the columns, and the components of the full moment collar assemblies through the stations of the steel fabrication facility,

modifying the digital model of at least one of the plurality of buildings to improve efficiency of the generated routes and stages.

D1. The method of D0, wherein the modifying step includes substituting a first full moment collar assembly type for a second full moment collar assembly type.

D2. The method of D0 or D1, wherein the modifying step includes substituting a beam listed in an inventory database for a beam in the modified digital model.

D3. The method of any of D0-D2, further including estimating a cost of construction of the plurality of buildings based at least in part on the generated routes and stages, and modifying the generated routes and stages to reduce the estimated cost.

D4. The method of any of D0-D3, wherein creating a station layout for a steel fabrication facility includes accessing a listing of available fixtures for fabrication of the full moment collar assemblies included in the plurality of buildings.

D5. The method of any of D0-D4, wherein the stored historical pricing data includes a material cost and a fabrication cost.

D6. The method of any of D0-D5, further including storing historical fabrication data for the parts in the part database, including an average amount of fabrication labor for each part.

D7. The method of any of D0-D6, further including calculating an estimated cost for each of two procurement options for the beams of the plurality of buildings, and selecting the procurement option having a lower estimated cost.

D8. The method of any of D0-D7, further including augmenting the station layout for the steel fabrication facility to increase fabrication capacity based on the list of parts generated in the parsing step.

E0. A computer program product for managing construction of a steel building frame, the computer program product comprising:

a non-transitory computer-readable storage medium having computer-readable program code embodied in the storage medium, the computer-readable program code configured to cause a data processing system to display a graphical user interface, the computer-readable program code comprising:

at least one instruction to define a part database including beams, columns, and components of a full moment collar assembly,

at least one instruction to store historical pricing data for the parts in the part database,

at least one instruction to create a station layout for a steel fabrication facility,

at least one instruction to receive digital models of a plurality of buildings, each including a steel frame having beams and columns connected by full moment collar assemblies,

at least one instruction to parse the received digital models to generate a list of parts in the plurality of buildings as defined in the part database,

at least one instruction to generate routes and stages for the beams, the columns, and the components of the full moment collar assemblies through the stations of the steel fabrication facility,

at least one instruction to modify the digital model of at least one of the plurality of buildings to improve efficiency of the generated routes and stages.

F0. A data processing system for project management of building construction, comprising:

a server hosting a program configured to receive a plurality of digital building models and generate a list of parts in the digital building models, the list including beams, columns, and beam-column connection assemblies; and

a computer in communication with the server over a network, a web browser on the computer executing a graphical user interface of the program;

wherein the program includes:
a database having an index of parametrically defined part types including components of each part type, historical fabrication data for each part type, an inventory of currently stored parts, and material pricing,
a fabrication module configured to define a fabrication capacity of one or more fabrication facilities, and
a production module configured to generate a production plan for all parts of the generated list of parts, according to the historical fabrication data for the corresponding part types, the inventory, the material pricing, and the defined fabrication capacity.

F1. The system of F0, wherein the beam-column connection assemblies include full moment connection collar components.

F2. The system of F0 or F1, wherein planning fabrication includes determining routing and staging of all parts on the generated list of parts for the one or more fabrication facilities.

F3. The system of F2, wherein the production module is configured to modify the generated list of parts.

F4. The system of any of F0-F3, wherein the fabrication module is further configured to track fabrication of the parts of the generated list of parts, by a unique identifying code assigned to each component of each part.

F5. The system of F4, wherein fabrication of the parts of the generated list of parts includes assembling components of a beam-column connection assembly, and the assembled connection assembly is assigned a unique identifying code tracked by the fabrication module.

F6. The system of any of F0-F5, wherein the defined fabrication capacity includes an inventory of fixtures used in fabrication of beam-column connection assemblies.

F7. The system of any of F0-F6, wherein for each part type in the database index, values for a plurality of parameters are stored in the database.

F8. The system of F7, wherein the parameters include weld length and number of bolt holes.

F9. The system of any of F0-F8, wherein the database index includes both a full moment connection collar assembly and each component of the assembly.

F10. The system of any of F0-F9, wherein planning fabrication of all parts of the generated list of parts includes minimizing an overall cost including a labor cost and a material cost.

F11. The system of any of F0-F10, further including an estimation module configured to calculate an estimated construction cost for each received digital building model based at least in part on the production plan from the production module.

### Advantages, Features, and Benefits

The different examples of the steel building frame construction cycle management software systems and associated methods described herein provide several advantages over known solutions for managing steel frame building construction. For example, illustrative examples described herein improve cost estimation accuracy.

Additionally, and among other benefits, illustrative examples described herein allow optimization of fabrication efficiency across multiple building projects.

Additionally, and among other benefits, illustrative examples described herein allow integration of fabrication schedules and material purchases for multiple building projects.

Additionally, and among other benefits, illustrative examples described herein allow management of material inventory through multiple fabrication stages and increasing part specificity.

Additionally, and among other benefits, illustrative examples described herein allow management of a dynamic fabrication capacity, including assigning existing capacity and scheduling fabrication of fixtures for expansion of capacity.

Additionally, and among other benefits, illustrative examples described herein allow analysis of multiple procurement approaches for cost efficiency over a group of building projects.

Additionally, and among other benefits, illustrative examples described herein allow visualization of organization-wide data for high level decision making.

No known system or device can perform these functions, particularly for custom fabricated building components. Thus, the illustrative examples described herein are particularly useful for construction of steel frame buildings with proprietary connection components and assemblies. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A computer implemented method of managing construction of a steel building frame, the method comprising:
defining a part database including beams, columns, and components of a full moment collar assembly,
storing historical pricing data for the parts in the part database,
creating a station layout for a steel fabrication facility,
receiving digital models of a plurality of buildings, each including a steel frame having beams and columns connected by full moment collar assemblies,
parsing the received digital models to generate a list of parts in the plurality of buildings as defined in the part database,
generating routes and stages for the beams, the columns, and the components of the full moment collar assemblies through the stations of the steel fabrication facility,
modifying the digital model of at least one of the plurality of buildings to improve efficiency of the generated routes and stages.

2. The method of claim 1, wherein the modifying step includes substituting a first full moment collar assembly type for a second full moment collar assembly type.

3. The method of claim 1, wherein the modifying step includes substituting a beam listed in an inventory database for a beam in the modified digital model.

4. The method of claim 1, further including estimating a cost of construction of the plurality of buildings based at least in part on the generated routes and stages, and modifying the generated routes and stages to reduce the estimated cost.

5. The method of claim 1, wherein creating a station layout for a steel fabrication facility includes accessing a listing of available fixtures for fabrication of the full moment collar assemblies included in the plurality of buildings.

6. The method of claim 1, wherein the stored historical pricing data includes a material cost and a fabrication cost.

7. The method of claim 1, further including storing historical fabrication data for the parts in the part database, including an average amount of fabrication labor for each part.

8. The method of claim 1, further including calculating an estimated cost for each of two procurement options for the beams of the plurality of buildings, and selecting the procurement option having a lower estimated cost.

9. The method of claim 1, further including augmenting the station layout for the steel fabrication facility to increase fabrication capacity based on the list of parts generated in the parsing step.

10. A computer program product for managing construction of a steel building frame, the computer program product comprising:
a non-transitory computer-readable storage medium having computer-readable program code embodied in the storage medium, the computer-readable program code configured to cause a data processing system to display a graphical user interface, the computer-readable program code comprising:
at least one instruction to define a part database including beams, columns, and components of a full moment collar assembly,
at least one instruction to store historical pricing data for the parts in the part database,
at least one instruction to create a station layout for a steel fabrication facility,
at least one instruction to receive digital models of a plurality of buildings, each including a steel frame having beams and columns connected by full moment collar assemblies,
at least one instruction to parse the received digital models to generate a list of parts in the plurality of buildings as defined in the part database,
at least one instruction to generate routes and stages for the beams, the columns, and the components of the full moment collar assemblies through the stations of the steel fabrication facility,
at least one instruction to modify the digital model of at least one of the plurality of buildings to improve efficiency of the generated routes and stages.

11. A data processing system for project management of building construction, comprising:
a server hosting a program configured to receive a plurality of digital building models and generate a list of parts in the digital building models, the list including beams, columns, and beam-column connection assemblies; and
a computer in communication with the server over a network, a web browser on the computer executing a graphical user interface of the program;
wherein the program includes:
a database having an index of parametrically defined part types including components of each part type, historical fabrication data for each part type, an inventory of currently stored parts, and material pricing,
a fabrication module configured to define a fabrication capacity of one or more fabrication facilities, and
a production module configured to generate a production plan for all parts of the generated list of parts, according to the historical fabrication data for the corresponding part types, the inventory, the material pricing, and the defined fabrication capacity.

12. The system of claim 11, wherein the beam-column connection assemblies include full moment connection collar components.

13. The system of claim 11, wherein planning fabrication includes determining routing and staging of all parts on the generated list of parts for the one or more fabrication facilities.

14. The system of claim 13, wherein the production module is configured to modify the generated list of parts.

15. The system of claim 11, wherein the fabrication module is further configured to track fabrication of the parts of the generated list of parts, by a unique identifying code assigned to each component of each part.

16. The system of claim 15, wherein fabrication of the parts of the generated list of parts includes assembling components of a beam-column connection assembly, and the assembled connection assembly is assigned a unique identifying code tracked by the fabrication module.

17. The system of claim 11, wherein the defined fabrication capacity includes an inventory of fixtures used in fabrication of beam-column connection assemblies.

18. The system of claim 11, wherein for each part type in the database index, values for a plurality of parameters are stored in the database.

19. The system of claim 18, wherein the parameters include weld length and number of bolt holes.

20. The system of claim 11, wherein the database index includes both a full moment connection collar assembly and each component of the assembly.
